(19) United States
(12) Patent Application Publication
(10) Pub. No.: US 2008/0166269 A1
(43) Pub. Date: Jul. 10, 2008

(54) Device For Analyzing a Liquid Sample

(75) Inventor: Paul Jansen, Mannheim (DE)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/911,239

(22) PCT Filed: Apr. 6, 2006
(86) PCT No.: PCT/EP06/61398

§ 371 Date: Feb. 25, 2008

(30) Foreign Application Priority Data
Apr. 12, 2005 (EP) 05007962.3

(51) Int. Cl. B01J 19/00; G01N 11/00

(52) U.S. Cl. 422/63; 422/102; 73/53.01

(57) ABSTRACT

The invention relates to an analysis device for analyzing a sample liquid (8) by means of a test element (5). The analysis device comprises a measuring arrangement for carrying out measurements on a sample liquid (8) taken up onto a test element (5). The measuring arrangement is accommodated in a housing (1) and comprises a test element receptacle unit. In the test element receptacle unit, the test element can assume at least one sample application position and an analysis position. Furthermore, the analysis device has a waste container (12) movably connected to the housing (1) and serving for receiving test elements (5, 17) after measurements have been carried out on the sample liquid (8) on the test elements (5) in the analysis position. The waste container (12) is arranged in such a way that a sample uptake location of a test element (5) positioned in the sample application position is accessible.

The invention relates to an analysis device for analyzing a sample liquid comprising a waste container for receiving used test elements.

For analyzing samples, for example body fluids such as blood or urine, test element analysis devices are often used in which the samples to be analyzed are applied to a test element and, if appropriate, react with one or more reagents in a test field on the test element before they are analyzed. Optical, in particular photometric, and electrochemical evaluation of test elements are the most common methods for rapidly determining the concentration of analytes in samples. Photometric and electrochemical evaluations are generally used in the fields of analysis, environmental analysis and primarily in the field of medical diagnosis. Test elements that are evaluated photometrically or electrochemically are of great importance particularly in the field of blood glucose diagnosis from capillary blood.

Portable measuring devices for blood sugar determination have gained in importance in recent years. They allow blood sugar measurement values to be determined at any time by means of an easy-to-operate measuring device, a puncture aid optimized with regard to the pain caused by the puncture, and a disposable test element, and in this way they allow more precise insulin dosage to be performed for the patient in order to stabilize his blood sugar value. Most of the presently customary blood sugar measuring devices provide separate individual test elements, measuring devices and puncture aids. In this case, the individual test elements are removed from a moisture-proof individual package by the patient. Blood is obtained by puncturing the skin with a puncture aid. A required minimum amount of blood is then applied to the test element, and a measurement is carried out with the aid of the measuring device.

There are various forms of test elements. For example, substantially square slides are known in the middle of which a multilayer test field is situated. Diagnostic test elements in strip form are referred to as test strips. For spatial separation of the detection zone and the sample application site of a test element, the prior art discloses capillary test elements, e.g. in WO 99/29429.

The package holding the respective test element is designed to fulfill the essential tasks for maintaining the function of the chemical and biochemical constituents on the test element during a relatively long storage period. These tasks are primarily protection against the action of light rays, protection against entry of moisture, dirt, microbes and dust, and protection against mechanical deterioration of the test elements.

As an alternative to individual packages, supply containers are known which comprise a multiplicity of individually removable test elements and provide a sufficiently large supply of desiccant for absorbing the moisture introduced by opening and removal of a test element, and thus for ensuring a sufficient storage period for all the test elements provided in the container. Such a supply container is disclosed in EP 0 640 393 B1. In the supply container, the test elements are held as in a quiver, from which they can be removed when the supply storage system is opened.

These separate supply containers have the disadvantage that the individual test elements have to be manually removed in a laborious manner. A patient wishing e.g. to carry out a blood sugar test has to carry around not only the measuring device but also a puncture aid and a separate test element supply container. Besides this inconvenience, a particular disadvantage is that, when a test element is removed, said test element and/or another one are/is contaminated, and the contamination can lead to incorrect measurement results. There is the risk of test strips becoming contaminated by dirt adhering to the patient's hands and on account of the test element falling out.

The storage of a specific number of test elements in the measuring device itself is known as an alternative.

DE 198 19 407 discloses a container for blood sugar measuring devices or other measuring devices operating with disposable test strips that can be fed to a sensor for measurement purposes, the container comprising two parts, in the first of which the test strips are stored and in the second of which the used test strips are collected. In this case, the test strips can be arranged alongside one another such that they form a tape, which can be wound similarly to the tape in an audio cassette. Instead of this, they can also be arranged so as to form a round disk, on which they are arranged at a defined distance from one another in the region of the disk circumference, such that, as a result of the disk being rotated, a new test field comes into the corresponding measurement position. A further possibility is for the test strips to form a stack which is processed individually by a mechanism and brings the test strips successively into the corresponding measurement position and, after the measurement has been effected, into a collecting compartment.

DE 198 54 316 A1 describes a supply container with separate water-vapor-proof chambers for test elements. Each of the chambers has at least two openings which lie opposite one another and are closed off by a respective sealing film. In order to remove the test elements, a test element is pushed out of its chamber with the aid of a ram. The ram in this case cuts through the sealing film on one side of the chamber and then presses onto the test element, which, on account of this pressure from the ram, cuts through the sealing film on the opposite side, such that the test element can be pushed out from the chamber. Further mechanisms for automatically removing test elements from a supply container are disclosed in EP 0 738 666 B1, DE 197 15 031 A1, U.S. Pat. No. 5,575,403, DE 199 02 601 A1 and DE 43 26 339 A1.

After a sample (e.g. blood) has been taken up onto the removed test element, detection and measurement data evaluation are effected in the analysis device. In the prior art, the used test elements are usually ejected or manually removed from the analysis device and have to be disposed of individually. Consequently, a test element contaminated with blood, control solution or other sample liquid is obtained after each measurement. This can be unpleasant for a user who has to use the analysis device in public and, for hygiene and discretion reasons, would prefer not to handle such used test elements in public.

It is an object of the present invention to provide an analysis device which avoids the disadvantages of the prior art and which permits, in particular, hygienic and discrete disposal of used test elements.

This object is achieved according to the invention by means of an analysis device for analyzing a sample liquid by means of a test element, comprising a measuring arrangement for carrying out measurements on a sample liquid taken up on a test element, the measuring arrangement being accommodated in a housing and comprising a test element receptacle unit, in which the test element can assume at least one sample application position and an analysis position.

Furthermore, the analysis device comprises a waste container movably connected to the housing and serving for receiving test elements after measurements have been carried out on the sample liquid on the test elements in the analysis position, the waste container being arranged in such a way that a sample uptake location of a test element positioned in the sample application position is accessible.

Any desired test elements known to the person skilled in the art can be used in the analysis device according to the invention. They are preferably single-use test strips with a test field containing a test chemical which are provided for photometric or electrochemical analysis of a sample liquid on the test field.

The supply container contained, if appropriate, in the analysis device according to the invention is for example a drum-type or stack-type magazine in which at least two, preferably between 10 and 100, test elements can be stored. The test elements can preferably be removed automatically from the supply container for use, e.g. by means of a ram or slide in the analysis device. However, it is also possible for the analysis device according to the invention not to contain a supply container, in which case a user has to carry around unused test elements in a separate supply container and insert them manually into the test element receptacle unit for measurement purposes.

In general, the test elements contain reagents, the reaction of which with the sample liquid leads to a physically detectable alteration of the analyte, which is measured with the aid of the measuring arrangement. The measuring arrangement is e.g. a measuring arrangement for photometric or electrochemical analysis of a sample present on the test element. Photometric analysis systems involve photometrically measuring e.g. a color change caused by a reaction of the analyte in the test field of the test element. The photometric measuring arrangement used for this purpose usually comprises a light source, optical elements and a detector for detecting light that is reflected at the test field or transmitted through the test field. In the case of electrochemical analysis systems, the reaction gives rise to an electrochemical alteration of the analyte in the test field, said alteration being measurable as voltage or current intensity. In this case, the measuring arrangement interacts with conduction elements present on the test element, for example printed or etched conductor tracks, which are connected to the measuring arrangement. The measured electrical signal is optionally amplified there, analyzed and displayed.

The measuring arrangement is accommodated in a housing and comprises a test element receptacle unit, in which the test element can assume at least one sample application position and an analysis position. The test element receptacle unit can define e.g. a cavity contained in the housing, in which cavity the test element can be displaced into different positions and be held there e.g. for sample application or analysis purposes. The sample application position is that position of the test element in the test element receptacle unit in which a sample liquid to be analyzed can be applied to a sample uptake location on the test element. In this case, the test element projects by an end having the sample uptake location, for example, from the housing of the analysis device. In the analysis position, the sample liquid on the test element is analyzed by the measuring arrangement. In the analysis position, the test element can be withdrawn completely into the housing. However, the analysis position can also correspond to the sample application position.

The housing surrounds the analysis device. It preferably has the form of commercially available analysis device housings and is formed compactly and in a form that is easy for the user to handle. It contains the measuring arrangement and, if appropriate, a supply container for receiving unused test elements. Furthermore, in the case of an integrated analysis device, it can e.g. also contain a puncture aid and a number of lancets.

According to the invention, the analysis device comprises a waste container, which is connected to the housing movably and, if appropriate, releasably and serves for receiving test elements after measurements have been carried out on the sample liquid on the test elements. The movable or releasable connection of the waste container to the housing has the advantage that it can be moved away (e.g. folded away) or released from the housing for the purpose of sample application to the test element, emptying and cleaning or for complete disposal. Furthermore, the waste container can be connected to the analysis device only as required, (e.g. if the user leaves his private domain, in particular when traveling, at school and work and for leisure activities), and the analysis device can otherwise be used without the waste container. By means of the waste container, the used test elements are automatically disposed of or stored in the waste container. The waste container augments e.g. a commercially available analysis device. It is e.g. a hollow form (e.g. in the form of a trough) which is to be fitted to the analysis device and which catches and keeps the used test elements ejected from the device. Therefore, the user does not need to immediately concern himself with disposing of test elements contaminated with sample liquid (e.g. blood). The test elements are stored such that they are not visible to third parties. Ideally, the waste container connected to the housing forms an optical unit with the housing of the analysis device. A matching exterior design of the waste container does not influence the functionality of the analysis device, but increases acceptance on the part of the user or “disguises” the function of the analysis device.

In the present invention, the waste container is arranged in such a way that the sample uptake location of a test element positioned in the sample application position is accessible to a user. Consequently, the user can apply the sample liquid without any problems to the sample uptake location of the test element situated in the sample application position. For this purpose, the waste container can be folded away e.g. from the housing during sample application and, during the analysis by the measuring arrangement, can be placed against the housing again or have an opening, through which the test element can be reached for sample application purposes.

In accordance with one preferred embodiment of the present invention, a snap-action connection, a frictional force connection, a hook and loop connection, magnets, clamps, plugs, screws, adhesive tape, plug-in or clamping strips, belts or cords or combinations thereof are provided for fixing the waste container to the housing. These can be provided on the housing and/or on the waste container.

In accordance with a further embodiment, the waste container is pivotably fixed to the housing.

Preferably, the waste container is an attachment which is open at least on one side and which can be placed onto the housing and is to be movably or releasably connected to the latter.

The analysis device according to the invention can furthermore comprise a transport device for transporting a test element from the supply container into a sample application position and into an analysis position and for ejecting the test element from the housing into the waste container. The transport device can contain a ram or slide, for example, by which a respective test element is pushed out from the supply container, the other test elements present in the supply container furthermore remaining sealed and protected in the supply container. Corresponding transport devices are described comprehensively in the prior art and familiar to the person skilled in the art in a multiplicity of embodiments. The transport device subsequently positions the removed test element in a sample application position, in which a sample liquid (e.g. blood or interstitial fluid) is applied to a sample uptake location on the test element. In the sample application position, the test element projects, e.g. by an end having the sample uptake location, through a slot from the housing of the analysis device according to the invention in order that the user can transfer the sample e.g. from his fingertip to the sample uptake location. The transport device then transports the test element with the sample liquid into an analysis position, in which the analysis (e.g. electrochemically or photometrically) of the sample is carried out. In the analysis position, the test element can be withdrawn e.g. completely into the housing. However, the analysis position can also correspond to the sample application position.

The transport device furthermore serves for ejecting the test element from the housing into the waste container. For this purpose, the transport device can have e.g. a spring mechanism. Alongside a spring mechanism, the test element can also be ejected by being simply pushed out e.g. by a ram or slide until it falls from the test element receptacle unit into the waste container.

In accordance with one preferred embodiment of the present invention, the analysis device according to the invention comprises a slot in the housing, through which the test element can be ejected from the housing into the waste container. Preferably, the slot is formed in such a way that the test element for sample uptake purposes projects partly from the slot.

One preferred embodiment of the present invention is configured in such a way that the waste container contains an opening, through which the sample liquid can be applied to a test element partly projecting from the housing. The opening is formed e.g. in such a way that the user can insert a finger with a drop of the sample liquid through the opening into the interior of the waste container in order to transfer the sample liquid to the sample uptake location of the test element partly projecting from the housing into the interior of the waste container. In this embodiment of the present invention, the already used test elements are preferably stored in some other region of the waste container sufficiently remote from the currently used test element partly projecting from the housing. The application of the sample liquid to the test element through the opening in the waste container has the advantage that the analysis of a sample liquid can be disguised even better and be carried out in the interior of the analysis device in a manner invisible to third parties. The user can also carry out a measurement when the waste container is connected to the housing. He can already connect the waste container to the housing of the analysis device in advance, e.g. before leaving home.

Preferably, the waste container, which is arranged movably with respect to the housing, is accessible in an open position and, in a closed position, receives the test elements ejected from the housing after the measurement has been carried out.

Furthermore, the waste container, which is arranged movably with respect to the housing, can remain at the housing while the measurement is being carried out by the measuring arrangement and while the test element is being ejected from said housing.

The geometry of the test element, the sample application position and the analysis position of the test element, the arrangement and form of the waste container and of the opening in the waste container are adapted to the respective analysis device. The waste container is formed in such a way that no used test elements can fall out from the waste container, and that the waste container is not released from the housing of its own accord. Preferably, the waste container, in particular the opening and/or its open end, can be closed off manually or automatically by a closure. The closure can be e.g. a cover for screwing or plugging, a sliding closure or a covering film. When the waste container is removed from the housing, e.g. in order to dispose of used test elements, the closure prevents said test elements from falling out from the waste container. Preferably, the waste container is closed off automatically. However, it is also possible for a closure to be fitted manually by the user. An automatic, i.e. self-closing, closure can be e.g. a clamp or snap-action closure, similar to a simple spectacle case closure or a “trapdoor” triggered by a spiral or leaf spring. A manual closure can be e.g. a traditional cover for plugging or screwing or a (self-adhesive) film with or without strip of rubber. A further alternative or additional possibility is for the waste container to have an adhesive inner side. The adhesive inner side alters the used test elements from falling around in the waste container since the test elements are fixed to the adhesive inner side.

The invention furthermore relates to a waste container for receiving test elements after measurements have been carried out in an analysis device comprising a housing on a sample liquid on the test elements, wherein the waste container contains means for movable or releasable connection to the housing of the analysis device. The connection means serve for externally fixing the waste container to the housing of the analysis device. The means for movable or releasable connection can be e.g. a snap-action connection, a frictional force connection, a hook and loop connection, magnets, clamps, plugs, screws, adhesive tape, plug-in or clamping strips, belts or cords or combinations thereof.

The invention furthermore relates to a method for analyzing a sample liquid by means of a test element in an analysis device comprising a housing, having the following steps:
uptake of the sample liquid onto a test element,
positioning of the test element into an analysis position of the analysis device,
analysis of the sample liquid by a measuring arrangement in the analysis device,
ejection of the test element from the housing of the analysis device into a waste container, which is movably connected to the housing.

In particular, the invention relates to a method for analyzing a sample liquid by means of a test element in an analysis device comprising a housing, having the following steps:
removal of a test element from a supply container in the analysis device,
transport of the test element into a sample application position,
uptake of the sample liquid onto the test element in the sample application position,
analysis of the sample liquid by a measuring arrangement in the analysis device,
ejection of the test element from the housing of the analysis device into a waste container, which is movably or releasably connected to the housing.

The invention is explained in more detail below with reference to the drawing.

### IN THE FIGURES

FIGS. 1(a)-(e) schematically show an analysis device from the prior art and its use,

FIGS. 2(a) and (b) schematically show an embodiment of an analysis device according to the invention,

FIGS. 3(a) and (b) schematically show a section through a waste container connected to the housing of an analysis device according to the invention, and

FIGS. 4(a)-(i)show various possibilities as to how, in an analysis device according to the invention, a waste container can be movably or releasably connected to the housing.

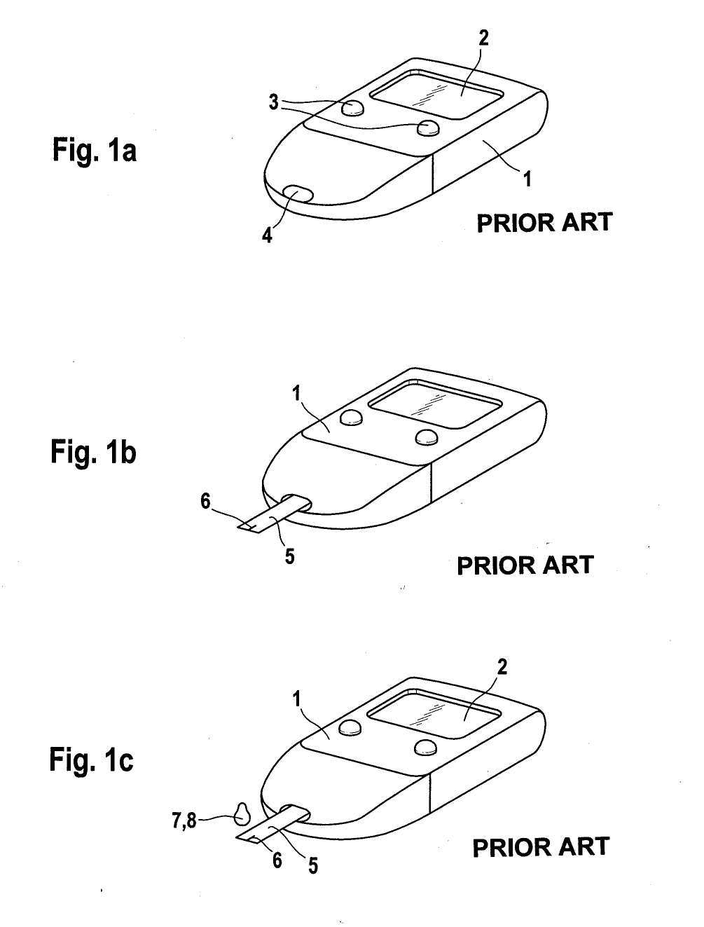

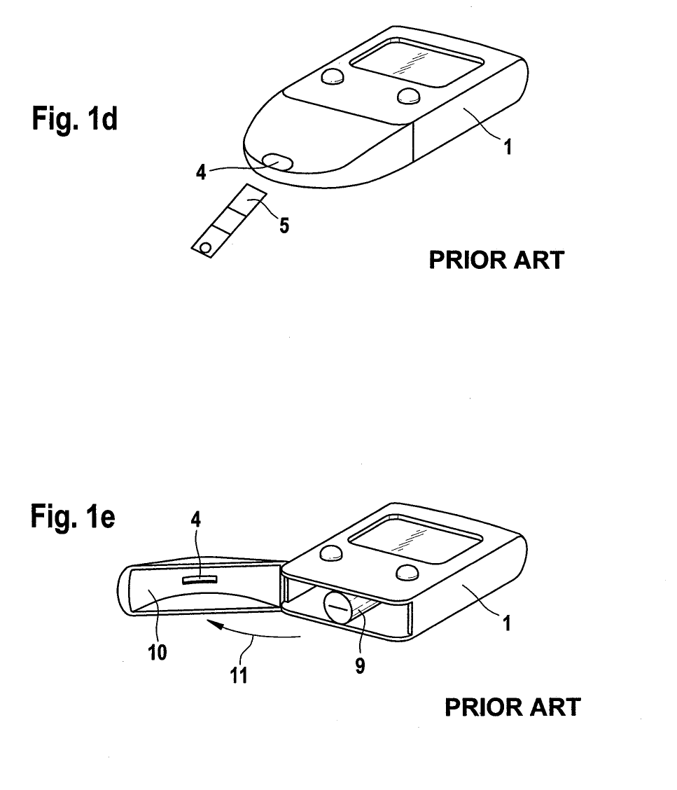

FIGS. 1(a)-(c) show an analysis device from the prior art.

The analysis device comprises a housing 1, in which is arranged, inter alia, a measuring arrangement (not illustrated) suitable for analyzing a sample liquid on a test element. FIG. 1(a) schematically shows the construction of the analysis device. The housing 1 comprises a display 2 for displaying analysis results or other information for the user. Furthermore, it has buttons 3 for the actuation of the analysis device (e.g. for starting the device or for menu control).

A slot 4 is formed in the housing 1, from which slot a strip-type test element 5 partly projects in FIG. 1(b). The test element 5 is situated in a sample application position, in which a sample uptake location 6 on the test element 5 is freely accessible for a user.

FIG. 1(c) illustrates the sample application to the test element 5. A sample liquid drop 7 (e.g. a drop of blood, control liquid or interstitial fluid) is applied to the sample uptake location 6. The analysis of the sample liquid 8 subsequently takes place in the analysis device. The analysis can be carried out e.g. electrochemically or photometrically. The result of the analysis is displayed on the display 2.

After the measurement, the used test element 5 is ejected from the analysis device (FIG. 1(d)). The user has to dispose of the test element 5 contaminated with sample liquid 8.

Unused test elements 5 can be provided in a supply container 9 in the analysis device (FIG. 1(e)). In order to change the supply container 9 and/or replenish unused test elements 5, a cover 10 of the housing 1 can be opened by pivoting in the opening direction 11. Individual test elements 5 can thus be inserted into the supply container 9 present or a new supply container 9 filled with a multiplicity of test elements 5 can be inserted into the analysis device. The analysis device removes and transports the test elements 5 automatically from the supply container 9 by means of a transport device (not illustrated) present in the housing 1. The transport device transports, in particular, a respective test element 5 from the supply container 9 into the sample application position (FIG. 1(b)) and, after sample application (FIG. 1(c)), into an analysis position and subsequently ejects the used test element 5 from the housing 1 (FIG. 1(d)). An analysis device from the prior art in accordance with FIG. 1 is e.g. the commercially available integrated system Accu-Chek® Compact from Roche Diagnostics, Germany.

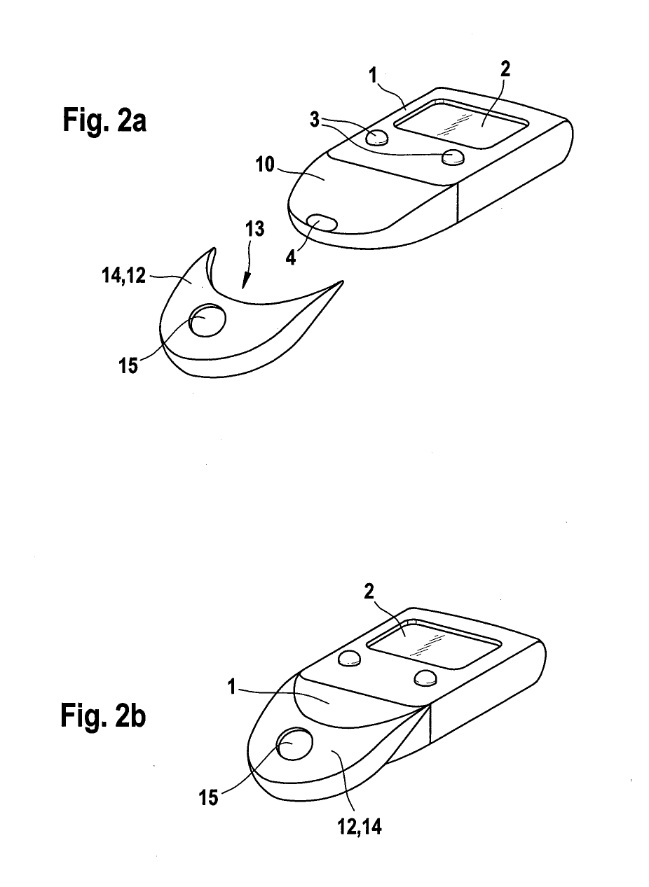

FIGS. 2(a) and (b) show an embodiment of an analysis device according to the invention with a waste container.

The particular embodiment of the analysis device according to the invention in accordance with FIG. 2 substantially corresponds to the analysis device from FIG. 1, such that the description with regard to FIG. 1 likewise applies to the analysis device from FIG. 2. The analysis device according to the invention in accordance with FIG. 2 additionally comprises a waste container 12, which is movably and/or releasably connected to the housing 1.

The housing 1 and the waste container 12 are illustrated separately in FIG. 2(a) and the two components 1, 12 are illustrated as connected to one another in FIG. 2(b). The waste container 12 is trough-shaped. It is an attachment 14 which is open on one side (open side 13) and which can be placed onto the housing 1 and is movably or releasably connected to the latter. The housing 1 contains a slot 4, through which, with the waste container 12 placed in position, a used test element can be ejected from the housing 1 into the waste container 12. The waste container 12 has an opening 15, through which a sample liquid can be applied to a test element (not illustrated) partly projecting from the slot 4 in the housing 1.

The analysis of a sample liquid by means of an analysis device according to the invention in accordance with FIG. 2(b) proceeds as follows:
removal of a test element 5 from a supply container 9 in the analysis device,
transport of the test element 5 into a sample application position,
uptake of the sample liquid onto the test element in the sample application position,
analysis of the sample liquid 8 by a measuring arrangement in the analysis device,
ejection of the test element 5 from the housing 1 of the analysis device into the waste container 12, which is movably or releasably connected to the housing 1.

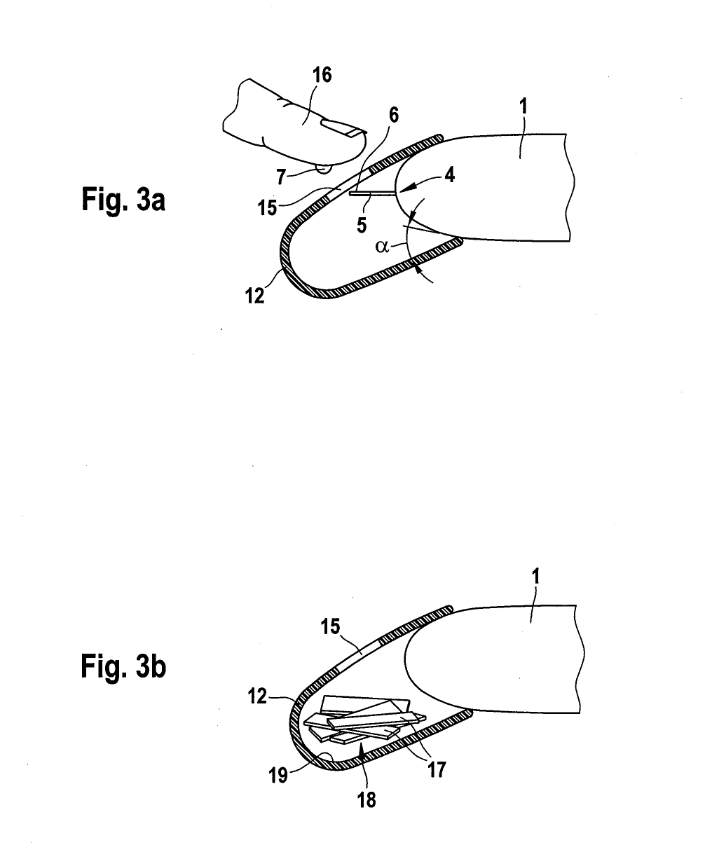

FIGS. 3(a) and (b) show a section through a waste container connected to a housing of an analysis device according to the invention. In this case, the waste container 12 is connected to an end of the housing 1 (only partly illustrated). In FIG. 3(a), a test element 5 arranged in sample application position projects from the housing 1, and a sample liquid drop 7 is transferred from the finger 16 of a user to the sample uptake location 6 of said test element. The waste container 12 is movably or releasably fixed to the housing 1 in a manner inclined by an angle α, such that the user can reach the sample uptake location 6 through the opening 15 without any problems and used test elements 17, given corresponding orientation of the analysis device, pass on account of the force of gravity into a collecting region 18 remote from the sample uptake location 6. The inner side 19 of the waste container 12 can be embodied in adhesive fashion, particularly in the collecting region 18, such that once used test elements 17 have arrived there they are fixed there.

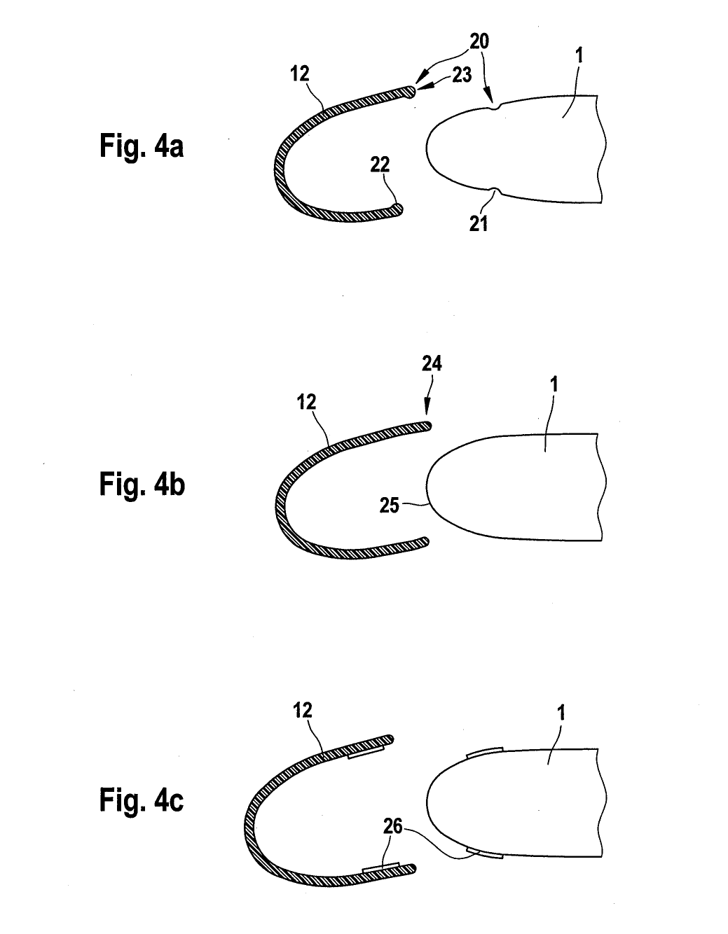

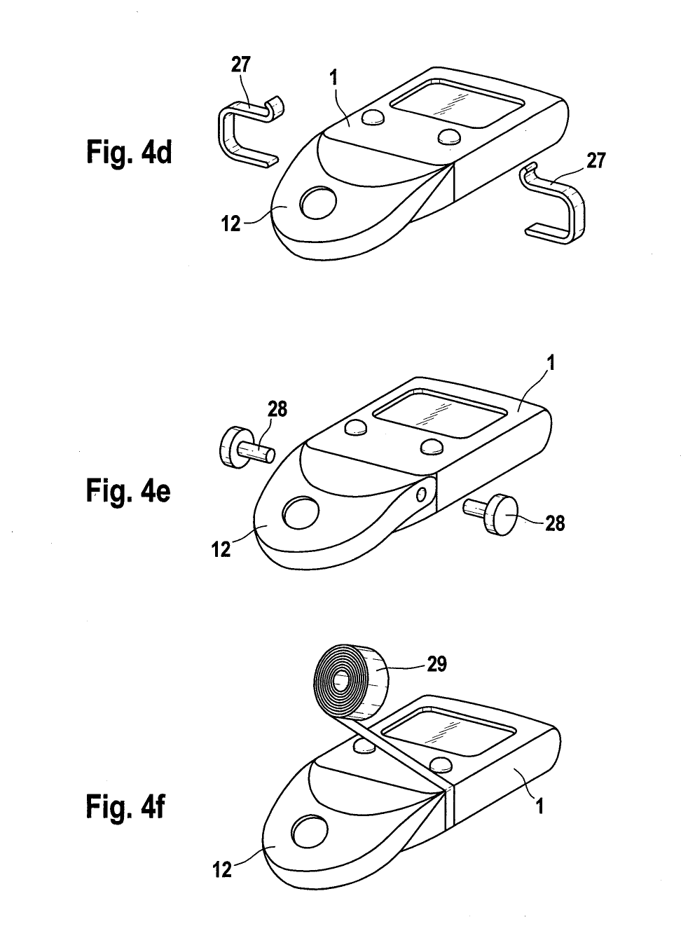

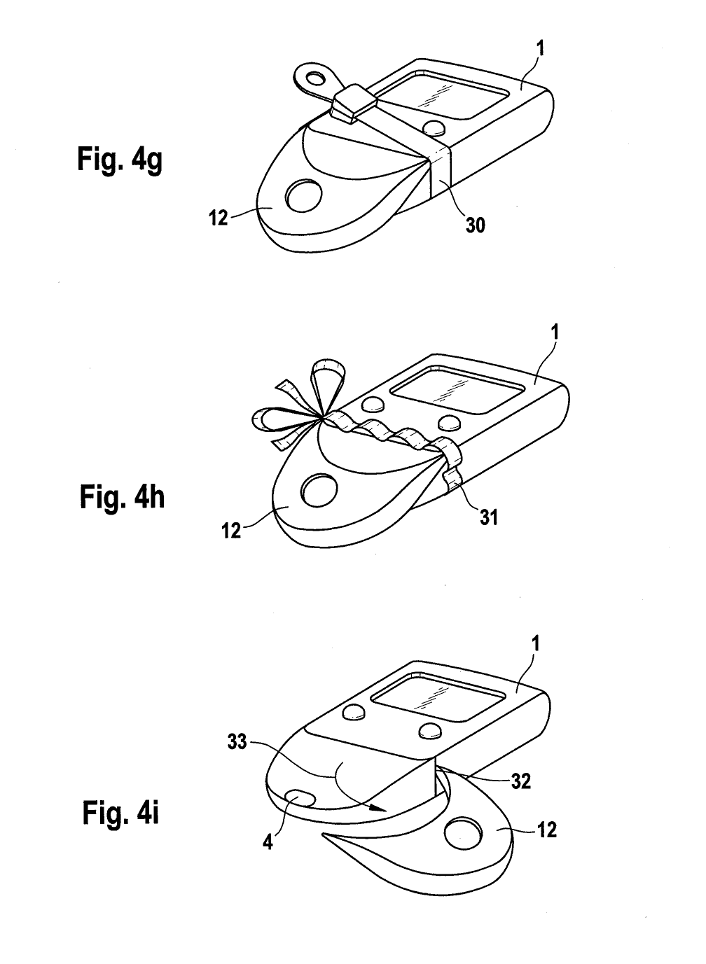

FIGS. 4(a)-(i) show various possibilities as to how, in an analysis device according to the invention, a waste container can be movably or releasably connected to the housing. This connection prevents inadvertent release of the waste container from the housing.

FIG. 4(a) illustrates a snap-action connection 20. In this case, the housing 1 has a groove 21, into which snaps the edge 23 of the waste container 12, said edge being provided with bulges 22.

FIG. 4(b) illustrates a frictional force connection 24. In this case, the waste container 12 is pushed onto the end 25 of the housing 1 and held there by friction. For this purpose, the end 25 can be e.g. roughened on its surface or be covered with a corresponding “nonslip” material (e.g. plastic or rubber).

FIG. 4(c) shows a hook and loop connection or connection by means of magnets. In this case, both the waste container 12 and the housing 1 have hook and loop elements or magnets 26.

Further means for the movable or releasable connection of the waste container to the analysis device that can be used for the present invention are
clamps 27 composed of metal or plastic (FIG. 4(d)),
plugs or screws 28 (FIG. 4(e)),
adhesive tape 29 (FIG. 4(f)),
all types of plug-in or clamping strips 30 (e.g. in the form of a zip fastener) (FIG. 4(g)) and
all types of belts or cords 31 (FIG. 4(h)).

The waste container 12 filled with used test elements is removed from the housing 1 in order to dispose of the used test elements. The waste container 12 can either be disposed of as a whole and be replaced by a new waste container 12, or it can be emptied, cleaned and reused.

FIG. 4(i) shows a waste container 12 fixed to the housing 1 such that it can be pivoted in pivoting direction 33 about an axis 32. This is e.g. advantageous in order, in the case of problems with a test element (becoming stuck in the slot 4 or the like), to reach it better.

### LIST OF REFERENCE SYMBOLS

1 Housing
2 Display
3 Buttons
4 Slot
5 Test element
6 Sample uptake location
7 Sample liquid drop
8 Sample liquid
9 Supply container
10 Cover
11 Opening direction
12 Waste container
13 Open side
14 Attachment
15 Opening
16 Finger
17 Used test elements
18 Collecting region
19 Inner side
20 Snap-action connection
21 Groove
22 Bulges
23 Edge
24 Frictional force connection
25 End of the housing
26 Hook and loop elements or magnets
27 Clamps
28 Plugs or screws
29 Adhesive tape
30 Plug-in and clamping strips
31 Belts or cords
32 Axis
33 Pivoting direction

1. A fluid analysis device comprising:
a housing;
a measurement engine located within the housing suitable for carrying out measurements; the measurement engine including a test interface; the test interface being sized and shaped to receive a test element therein; and
a waste container movably coupled to the housing, the waste container having a containing position and an access position, the waste container being sized and shaped such that a liquid sample can be applied to a test element positioned in the test interface when the waste container is in the containing position.

2. The analysis device of claim 1, wherein that the waste container is releasably connected to the housing.

3. The analysis device of claim 1, further comprising a supply container for housing one or more unused test elements.

4. The analysis device of claim 1, wherein the waste container is movably coupled to the housing via connection selected from a snap-action connection, a frictional force connection, a hook and loop connection, magnets, clamps, plugs, screws, adhesive tape, plug-in or clamping strips, belts or cords, and combinations thereof.

5. The analysis device of claim 1, wherein the waste container is pivotably fixed to the housing.

6. The analysis device of claim 1, wherein the waste container is an attachment which is open on at least one side and which is releasably connected to the housing.

7. The analysis device of claim 3, further comprising a transport device for transporting a test element into an analysis position and for ejecting the test element from the interface into the waste container.

8. The analysis device of claim 1, wherein the test interface includes a slot in the housing through which the test element can be ejected from the housing into the waste container.

9. The analysis device of claim 8, wherein the slot is sized and shaped such that the test element, when received therein, projects partly from the slot (4).

10. The analysis device of claim 1, wherein the waste container contains an opening through which a sample liquid can be applied to a test element projecting partly therefrom with the waste container being positioned in the containing position.

11. The analysis device of claim 1, wherein the waste container is accessible in the access position and the waste container receives the test elements ejected from the housing after the measurement has been carried out in the containing position.

12. The analysis device of claim 1, wherein the waste container is positioned in the containing position while the measurement is being carried out by the measuring arrangement and during ejection of the test element from said housing.

13. The analysis device of claim 1, further including a closure sized and shaped to manually or automatically close off the waste container.

14. The analysis device as claimed in claim 13, wherein the closure is selected from the group of a cover for screwing or plugging, a sliding closure or a covering film.

15. The analysis device of claim 1, wherein the waste container has an adhesive inner side.

16. A method for analyzing a sample liquid in an analysis device including the steps of:
receiving the sample liquid onto a test element,
positioning the test element into an analysis position,
analyzing the sample liquid by a measuring arrangement in the analysis device, and
ejecting the test element from a housing of the analysis device into a waste container which is movably connected to the housing.

17. The method of claim 16, further including the step of placing the waste container in a containing position; the receiving, positioning, analyzing, and ejecting steps all being performed after the placing step.

18. The method of claim 17, wherein the placing step includes the step of maintaining the waste container in the containing position during the receiving, positioning, analyzing, and ejections steps.

19. The method of claim 16, further including the step of placing the waste container in an access position.

20. The method of claim 19, further including the step of removing the test element from the waste container when the waste container is in the access position.
